(19) United States
(12) Patent Application Publication
(10) Pub. No.: US 2024/0375125 A1
(43) Pub. Date: Nov. 14, 2024

(54) CENTRIFUGE WITH SAFETY SHUTTER

(71) Applicant: STRATEC SE, Birkenfeld (DE)

(72) Inventors: Fabian Sturm, Birkenfeld (DE); Sebastian Schlor, Birkenfeld (DE)

(21) Appl. No.: 18/144,598

(22) Filed: May 8, 2023

(30) Foreign Application Priority Data
Sep. 27, 2022 (LU) LU103024

(51) Int. Cl. B04B 9/02; B04B 7/02

(52) U.S. Cl. CPC B04B 9/02; B04B 7/02

(57) ABSTRACT

A device and a method for the centrifugation of samples in a container for separating compounds of a fluid and provides a centrifuge for separating compounds of a fluid, comprising a housing surrounding a centrifugation chamber; a lid with an opening; a printed circuit board; a rotor with a plurality of container holders; and a shutter which partly covers the lid, wherein the shutter comprises an opening which is arranged above the opening of the lid; a stepper motor for actuating a toggle lever which is connected to a rotatable flap that is arranged above the opening of the lid and below the opening of the shutter.

### CROSS-REFERENCE TO RELATED APPLICATIONS

The present application claims priority to Luxembourg Patent Application No. LU 103024 filed on Sep. 27, 2022. The aforementioned application is hereby incorporated by reference in its entirety.

### BACKGROUND OF THE DISCLOSURE

### Field of the Disclosure

The invention relates to a device and a method for the centrifugation of samples in a container for separating compounds of a fluid.

### Brief Description of the Related Art

Automated analyser systems for use in clinical diagnostics and life sciences are produced by a number of companies. For example, STRATEC® SE, Birkenfeld, Germany, produces a number of devices for specimen handling and detection for use in automated analyser systems and other laboratory instrumentation.

Samples from patients which are to be processed in automated analyser system are often not supplied as whole sample but in fractions obtained from the whole sample. Different methods are known for separating the required part or information from a patient sample. Centrifugation is a process for separating solids from fluidic parts of a patient sample or for the separation of fluids of different density.

Centrifugation is a mechanical process using centrifugal forces for separating particles from liquids depending on their size, shape, density, and the viscosity of a fluid. The samples for centrifugation are stored in a container which is placed into a rotor with recesses for receiving the container. The separation process depends also on the rotor speed. The so-called pellet or precipitate is collected at the bottom of the container and the fluid above a pellet is called supernatant.

In the field of in vitro diagnostics, centrifuges are used to prepare samples for analysis. A centrifuge module is used to pick up container like tubes with samples for centrifugating them. This step is often time consuming, because the containers have to be applied appropriately in the rotor due to the high rotor speed that is later on applied.

Published U.S. patent application US 2014/135197 A1 discloses a housing for an automated centrifuge with side and top access. The housing includes an inner housing for enclosing at least one labware nest of the automated centrifuge, the inner housing having a top and a substantially cylindrical body, wherein the inner housing includes an opening through both a portion of the top and a portion of the body; and a door configured to move between an open position in which the door exposes the opening and a closed position in which the door blocks the opening.

Published European patent EP 0 596 199 B1 relates to cover for the inspection opening in the cover plate of the housing of a centrifuge, in particular of a vertical centrifuge, which is articulated to the housing, has a circumferential seal in the edge region, and is movable by means of an actuating device hinged to the cover, characterized in that the lid is articulated to the lid plate by means of at least one multi-joint lifting device and the actuating device is in the form of a piston rod of a hydraulic cylinder supported on the cover plate is articulated to the multi-joint lifting device.

Thus, there is a need for a save and automatic application of container with samples in a centrifuge unit.

### SUMMARY OF THE INVENTION

The present invention provides a centrifuge for separating compounds of a fluid, comprising
a housing surrounding a centrifugation chamber;
a lid with a first opening;
a printed circuit board;
a rotor with a plurality of container holders; and
a shutter which partly covers the lid, characterized in that the shutter comprises
a second opening which is arranged above the first opening of the lid;
a stepper motor for actuating a toggle lever which is connected to a rotatable flap that is arranged above the first opening of the lid and below the second opening of the shutter.

A further aspect of the invention relates to a centrifuge, wherein the rotor is connected to an EC motor with encoder.

In another embodiment of the centrifuge, the plurality of container holders is radially arranged around a central axis of rotation.

It is also envisaged that the plurality of container holders is movably and spring-loaded connected to the rotor allowing each container holder to swing-out due to centrifugal forces.

The centrifuge may provide a spring-loaded connection of the plurality of container holders to the rotor, wherein an axis and a spring surround said axis of swing-out of each container holder.

Another embodiment relates to a centrifuge, wherein the toggle lever comprises a first lever which is connected on one side to the stepper motor and on the other side through a joint-pin to a second lever which is connected to the flap.

Another aspect of the invention relates to a centrifuge, wherein the shutter comprises a first light barrier arranged at the stepper motor and a second light barrier arranged at the flap.

It is envisaged that the first lever comprises a recess.

In another embodiment of a centrifuge, the end of first lever which is connected to the stepper motor is configured to interrupt the first light barrier and the flap is configured to interrupt the second light barrier.

Is also intended that the centrifuge comprises on the outside of the housing a counterweight container holder for accommodating a counterweight container.

The rotor of a centrifuge according to the invention may comprise a stop for limiting the swing-out angle of the plurality of container holders.

Another object of the invention relates to a method for loading and unloading container to a rotor of a centrifuge with a gripper, comprising the steps of
monitoring the speed of rotation of a rotor;
opening a flap of a shutter, when the rotor speed is below a pre-defined threshold by actuating a stepper motor of the shutter, wherein the stepper motor is connected by a toggle lever to a flap that is arranged above the first opening of the lid and below an upper plate of the shutter;
stopping the rotation of the rotor;
loading or unloading a container into or from a container holder with a gripper;
closing the first opening of the lid by actuating the stepper motor connected to the flap;
monitoring whether the flap is closed by a first light barrier that is arranged at the stepper motor and a second light barrier that is arranged at the flap; and
accelerating the rotor when the flap of the shutter is closed.

The method may comprise the step of detecting the position of a container holder using an EC motor with an encoder.

It is envisaged that the rotor rotates clockwise or counter clockwise depending on the detected position of the container holder for loading or unloading.

In an embodiment of the method, the flap of the shutter is opened when the rotor is stationary.

Still other aspects, features, and advantages of the present invention are readily apparent from the following detailed description, simply by illustrating preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### SUMMARY OF THE FIGURES

The invention will be described based on figures. It will be understood that the embodiments and aspects of the invention described in the figures are only examples and do not limit the protective scope of the claims in any way. The invention is defined by the claims and their equivalents. It will be understood that features of one aspect or embodiment of the invention can be combined with a feature of a different aspect or aspects of other embodiments of the invention, in which:

FIG. 1 shows a perspective view onto a centrifuge according to the invention.

FIG. 2 shows a sectional view through a centrifuge according to the invention.

FIG. 3 shows the lid of centrifuge with PCB and shutter.

FIG. 4 shows a fixation tool that is used for mounting the rotor in the centrifuge.

FIG. 5 shows the mechanical interface of the centrifuge for fixation.

FIG. 6 shows a top view onto a shutter.

FIG. 7 shows the bottom side of the shutter with a closed flap.

FIG. 8 shows the bottom side of the shutter with a completely opened flap.

FIG. 9 shows the bottom side of the shutter during opening or closing of the flap.

FIG. 10 shows the toggle lever just before reaching its dead point.

FIG. 11 shows the teach tool separately on the right side and the mounted teaching tool in the centrifuge.

FIG. 12 shows a detailed top view onto the container holder.

FIG. 13 shows a sectional view through a rotor in a housing with an upright container holder for loading or unloading.

FIG. 14 shows a sectional view through a rotor in a housing with the container holders in a maximum swing-out angle of about 45°.

### DETAILED DESCRIPTION OF THE INVENTION

The technical problem is solved by the independent claims. The dependent claims cover further specific embodiments of the invention.

The term container refers within the present disclosure to a device which provides cavities, receptacles, or recesses for receiving a fluid which can be a liquid like a patient sample for instance. The term fluid refers to a liquid or gas which both may comprise solids. A patient sample may be any body liquid like whole blood, urine, lymph or saliva.

The present invention relates to a centrifuge which allows for an automated loading of container to the centrifuge and the centrifugation of the container within the centrifuge. The centrifuge comprises a locking of the loading and unloading position of the centrifuge via a novel locking mechanism, a so-called shutter within the description of the invention. Said shutter is an interface for automatic loading and unloading of the container via a gripper.

The centrifuge according to the present invention allows a continuous rotation of the rotor and the rotor runs clockwise and counter clockwise. In an embodiment of a centrifuge according to the present invention, the rotor has container holders for up to a maximum of sixteen containers. It is further possible to centrifuge an odd number of containers using an unbalance container as counterweight.

The container holder is mounted spring-loaded on an axis of rotation to the rotor so that the container holder can swing out during rotation. The maximum swing-out angle of a container holder is about 45° which is mechanically limited by a stopper of the rotor.

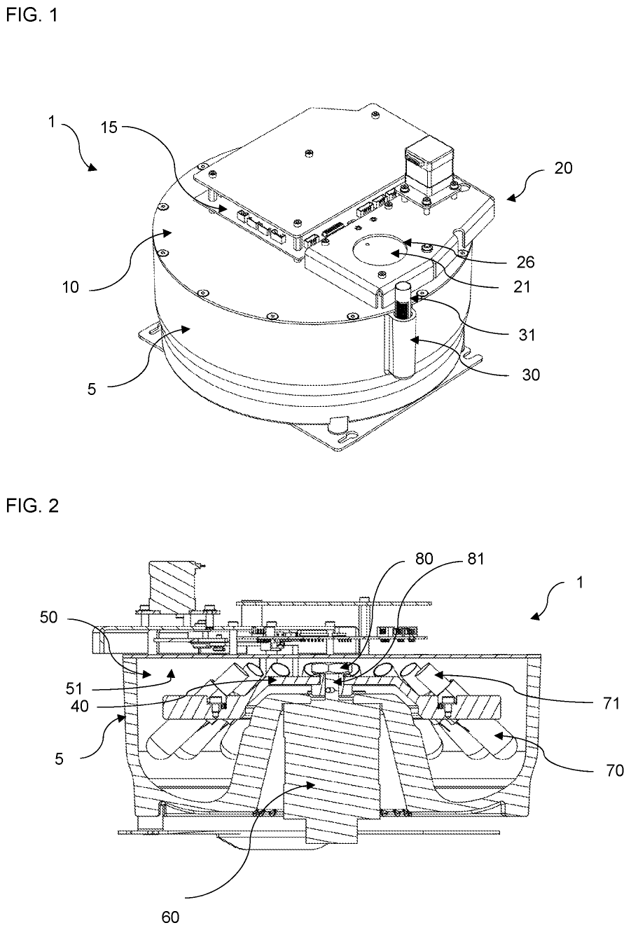

FIG. 1 shows a perspective view onto a centrifuge 1 according to the invention. The embodiment of the centrifuge 1 depicted in FIG. 1 comprises a housing 5, a centrifugation chamber 50 with a first opening 51 (comp. FIG. 2), a lid 10, a printed circuit board (PCB) 15 and a shutter 20.

The shutter 20 has a second opening 26 which is closed by a flap 21 to the centrifugation chamber 50 below lid 10 inside housing 5. Through the second opening 26, a gripper (not shown) can load and unload container into or from the container holder (not shown) of the centrifuge's rotor. Flap 21 is arranged below second opening 26 as a closing mechanism of the shutter 20. Shutter 20 opens and closes the second opening 26 and thus controls the access to the centrifugation chamber 50.

On the outside of housing 5 is a counterweight container holder 30 arranged for receiving a counterweight container 31 for imbalance correction. The weight of the counterweight container 31 corresponds to the mass of a filled sample container (not shown) for having an even number of containers at hand so that the mass applied to the rotor of the centrifuge has no imbalance during centrifugation.

FIG. 2 shows a sectional view through a centrifuge 1 according to the invention. The centrifugation chamber 50 is inside the housing 5 of the centrifuge 1 together with an EC motor with encoder 60, a rotor 40 and container holders 70 for holding the container 71. The rotor 40 is attached to the EC motor with encoder 60 via a nut 80 and comprises the container holders 70 which are arranged radially around the central axis of rotation 81. The EC motor with encoder 60 monitors the position of the rotor 40 and accelerates rotor 40 so that the container holders 70 swing out at a certain rotational speed.

The position of rotor 40 is monitored via the incremental encoder and an index pin. For the initialization of the rotor position after each switch-on, the initial position is determined by means of the index pin. For this purpose, the rotation of the rotor 40 at the position where the index pin is located triggers an electrical impulse on the index track and thus determines the initial position.

In addition, the EC motor 60 comprises Hall sensors for motor commutation. The signals of the Hall sensors are further used in addition to the encoder signals for monitoring the speed of the rotor 40 (safety-critical, therefore redundancy). Monitoring the speed is relevant for loading the container 71 into the container holders 70. During loading, the shutter 20 is open, so the rotor 40 may only rotate slowly for continuous loading with the shutter 20 open. If the speed increases above a pre-defined limit with the shutter 20 open, the rotor 40 is stopped by the electronics for safety reasons. The speed may only be increased for centrifuging via the EC motor 60 after the shutter 20 is closed.

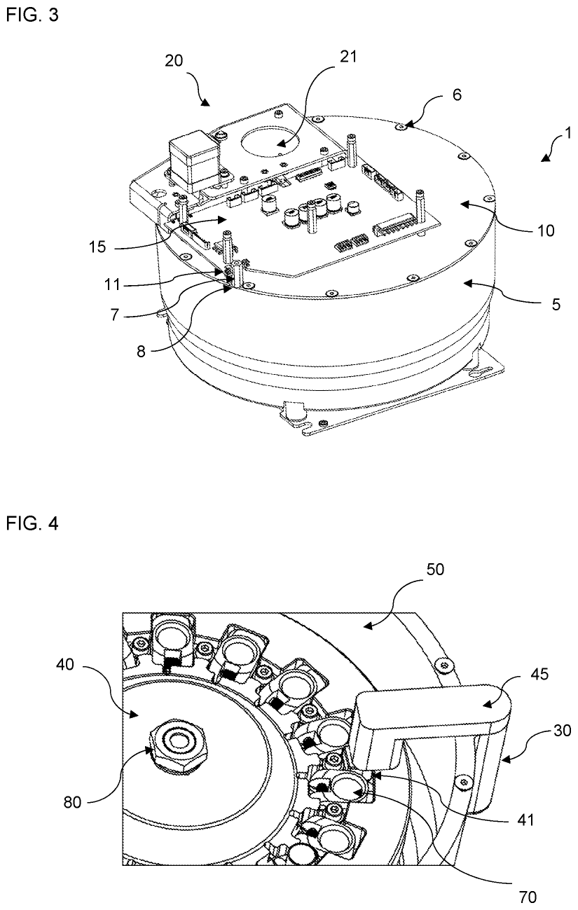

FIG. 3 shows the lid 10 of centrifuge 1 with PCB 15 and shutter 20. The PCB 15 and the shutter 20 are located on the upper surface of lid 10. The lid 10 is attached to housing 5 with screws 6. A light barrier 11 is arranged on the PCB 15 for monitoring the positioning of the lid 10 on the housing 5. For monitoring purposes, a bolt 7 is attached to the lid 10. When lid 10 and housing 5 are fixed to another, bolt 7 interrupts light barrier 11 on the PCB 15 through a recess 8 in the lid 10. This safety feature ensures that the lid 10 is on the housing 5 when the samples are centrifuged.

The PCB 15 provides all necessary cable connections for the centrifuge. This centrifuge assembly is connected to an external control unit via plug-in connections for power and data transmission.

FIG. 4 shows a fixation tool 45 that is used for mounting of rotor 40 into the centrifuge. The fixation tool 45 prevents the rotor 40 from rotating when the nut 80 is tightened. The fixation tool 45 is inserted into a single container holder 30 of the unbalance correction tube of the housing and into a recess 41 between the container holder 70 of the rotor and the centrifugation chamber 50.

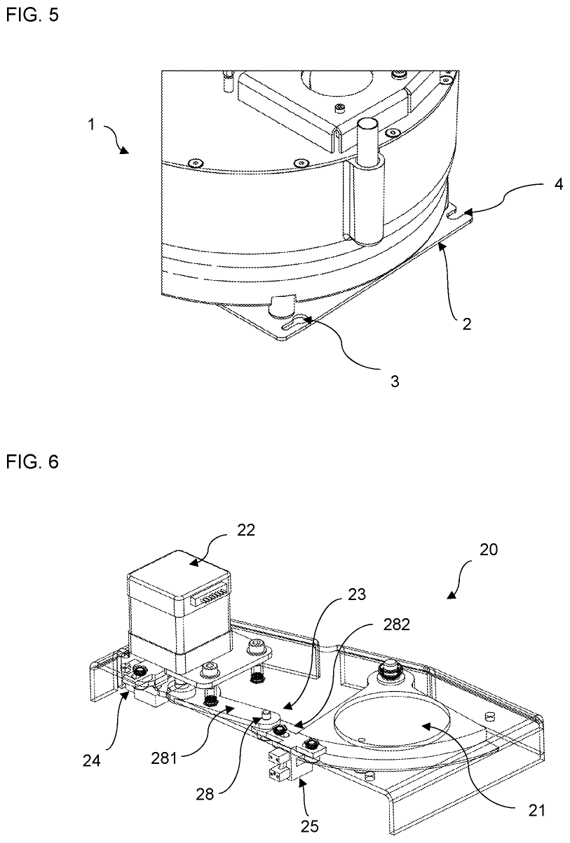

FIG. 5 shows the mechanical interface of the centrifuge for fixation. The centrifuge 1 is fixed directly to a chassis housing with four screws. FIG. 5 shows that the base plate 2 comprises at least two keyholes 3 and two slotted holes 4 for easy mounting to the chassis.

FIG. 6 shows a perspective top view onto a shutter 20 which comprises a stepper motor 22, a flap 21, a toggle lever 23 comprising two lever elements, a light barrier 24 arranged at the stepper motor 22 and a light barrier 25 arranged at the flap. The flap 21 is connected to the stepper motor 22 via the toggle lever 23 comprising first lever 281 connected by pin-joint 28 to second lever 282 so that the stepper motor 22 can retract and extend the flap 21 by moving the toggle lever 23. To ensure the positioning of the flap, two complementary light barriers 24, 25 are used to monitor the position of flap 21.

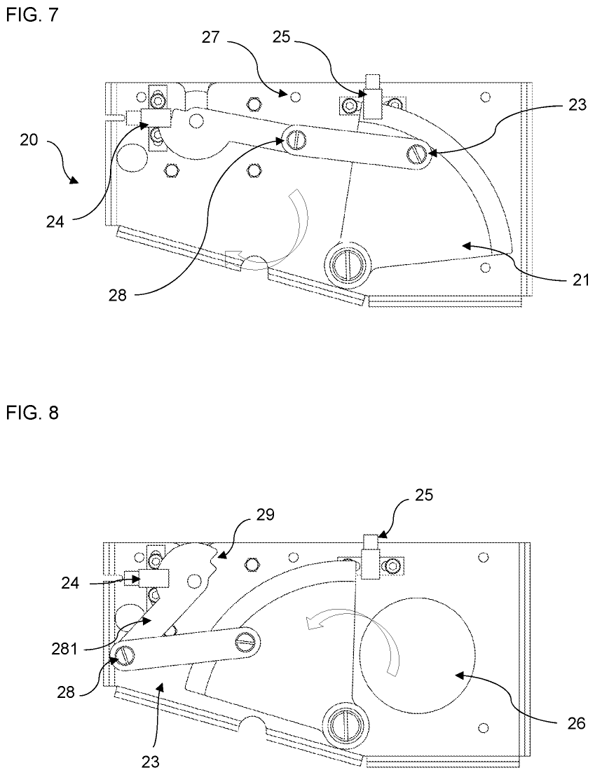

FIG. 7 shows the bottom side of the shutter with a closed flap 21 and FIG. 8 shows the bottom side of the shutter with a completely opened flap 21. The flap 21 of the shutter is opened for loading or unloading to allow access for the gripper (not shown) via the opening 26 to the container holders of the rotor. The stepper motor (not visible) rotates the toggle lever 23 comprising two levers which are connected by a pin-joint 28 clockwise (indicated by the arrow in FIG. 7) so that the flap 21 rotates as indicated by the arrow in FIG. 8 and provides access to the centrifuge (not shown) through opening 26.

The position of flap 21 is monitored via the two light barriers 24, 25. When the flap is closed (FIG. 7), the light barrier at the flap 25 is interrupted by the flap 21 and the light barrier at the stepper 24 is not interrupted due to a recess 29 in the first lever 281 which can be seen in FIG. 8. When the flap 21 is completely open (FIG. 8), the light barrier at the stepper motor 24 is interrupted and the light barrier on the flap 25 is not interrupted.

First lever 281 of toggle lever 23 is moved counter clockwise by stepper motor 22 for closing flap 21. The rotation ends when the toggle lever is over its dead point at stop 27 (FIG. 7). In this position, the toggle lever 23 is at the stop 27 and above its dead point, i.e., the toggle lever is overridden in this position so that a self-locking locking effect is achieved. This prevents the flap 21 from opening if vibrations may occur or from being opened manually when the centrifuge is switched on or off. The flap 21 can only be re-opened via the stepper motor 22.

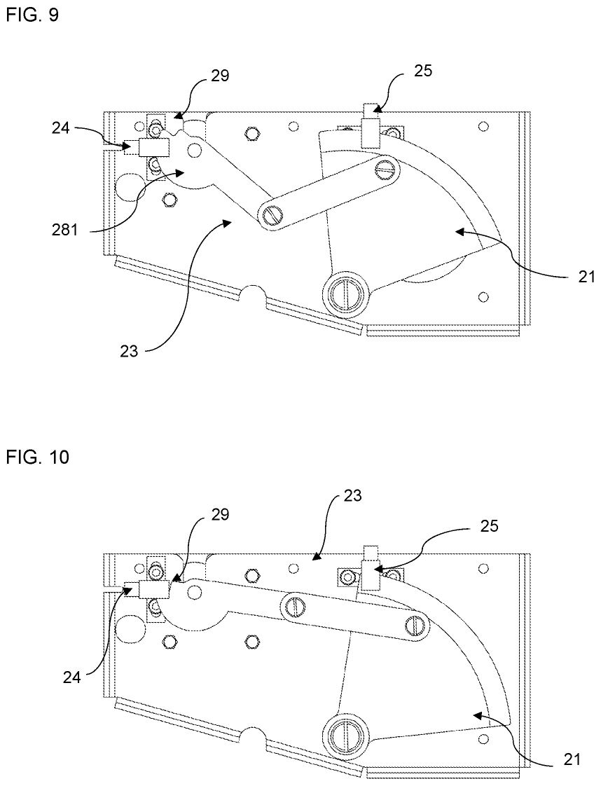

FIG. 9 shows the bottom side of the shutter 20 during opening or closing of the flap 21 in an intermediate position. The recess 29 on first lever 281 is visible. During opening or closing of flap 21, both light barriers 24, 25 are interrupted so that this intermediate position can be distinguished form a fully opened or fully closed flap 21.

FIG. 10 shows the toggle lever 23 just before reaching its dead point. In this position, the flap 21 is not yet completely closed. The light barrier on the flap 25 and the light barrier on the stepper motor 24 are still both interrupted.

Due to the complementary light barriers, the “open flap” and “closed flap” positions on the shutter are fixed, so that the precision of the stepper motor has no influence on the function of the shutter. Table 1 summarizes how the status of the flap can be derived from the state of the light barriers 24, 25.

TABLE 1
Light Barrier Logic

| Flap | Light Barrier Motor | Light Barrier Flap |
|---|---|---|
| Opened safely | interrupted | Not interrupted |
| undefined | interrupted | interrupted |
| Closed safely | Not interrupted | interrupted |

For automated loading and unloading of the containers by means of grippers, the

position of the container holder is controlled and monitored with the encoder and EC motor.

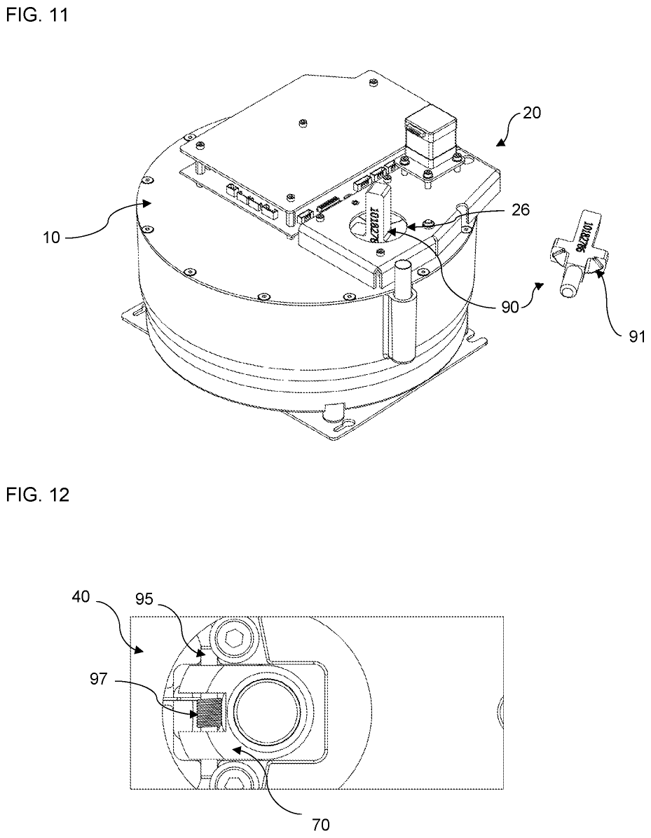

To align the rotor to the opening on the lid, a teaching tool and software are used for initial positioning. FIG. 11 shows the teach tool 90 separately on the right side and the mounted teach tool in the centrifuge. In a first step, the rotor and the shutter are initialised. The rotor moves to a so-called initialisation position using the incremental encoder and the index pin. The shutter is closed during initialisation. In the next step, the shutter is opened as described above. After the opening on the shutter is completely open, the rotor is de-energised.

A container holder is now located under the second opening 26 of the shutter 20. For the central alignment of the container holder to the second opening 26 of the shutter 20, the cross-shaped teach tool 90 is inserted manually. The teach tool is inserted via the second opening 26 of the shutter 20 into said second opening 26 and into the container holder (not visible). Following a correct insertion, the teach tool 90 is in the container holder and rests on the metal cover of the lid. On the underside of the teach tool 90 there is a small elevation 91 which defines the diagonal of the second opening 26 of the shutter 20. Said elevation 91 is located in the second opening 26 of the shutter 20 when the teach tool 90 is inserted. When the teach tool is inserted, the rotor rotates until the container holder is directly in the middle under the second opening 26 of the shutter 20. The container holder in the rotor is now aligned centrally in the second opening 26 of the shutter 20 of the centrifuge 1. The resulting so-called teaching position with offset value is stored in the external non-volatile memory. The EC motor with encoder calculates the other positions of the container holders.

The teaching possibilities of the gripper are limited compared to the pipettor. For this reason, the pipettor is used for the teaching process of the gripper and the values determined are then converted to the gripper. This is possible because the pipettor and the gripper move in the same coordinate system. The pipettor is taught via an auto teach process as disclosed in published British patent application GB 2540646 A. In the next step, the determined values are converted to the contour shape (diameter etc.) of the gripper during the teaching process with the pipettor. For the transfer of the values to the gripper, the determined values are converted to the gripper by the pipettor using known offset values.

For the auto teach process, the pipettor first moves to the stop with the lid of the centrifuge (position next to the shutter) for the Z-value by means of a capacitive sensor. Then the pipettor moves to the opening on the lid of the centrifuge and slightly lower than the determined Z value (=Z position of the lid of the centrifuge). In the opening on the lid of the centrifuge, the pipettor determines the x/y values of the loading position. To determine the centre of the opening, the pipettor moves in the X direction until it comes to a stop with the inner perforated wall. Then the pipettor moves in the opposite X-direction to the stop. The average value is calculated from these two values. The pipetting device repeats this procedure for the Y-direction. To determine the centre of the opening of the lid, the two average values (X and Y) are superimposed and saved.

From the taught values for determining the loading position, the position of the unbalance correction tube is determined with the help of known offset values.

FIG. 12 shows a detailed top view onto the container holder 70 which is spring-mounted on axis 95 and can be rotated so that the container holder 70 can swing out during rotation of the rotor 40. Due to the pre-tension of the spring 97, the container holder 70 is in an upright position during loading and unloading for the gripper. As described above, an EC motor with encoder is used to determine the position and centrifuge the container holder.

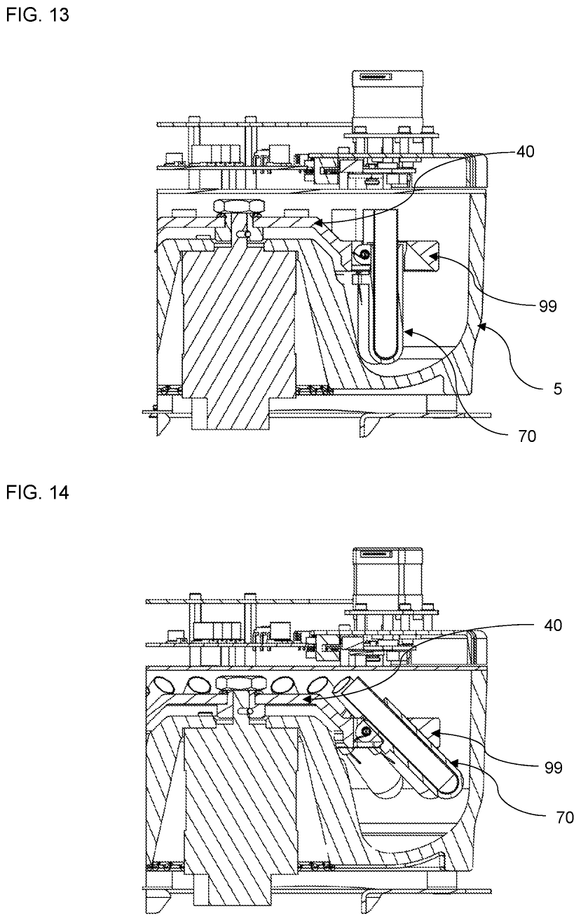

FIG. 13 shows a sectional view of a rotor 40 in a housing 5 with an upright container holder 70 for loading or unloading. For centrifugation, the flap on the shutter (both not shown) is opened via the stepper motor (not shown) as described above. When the flap is completely open and the rotor is stationary, the gripper can insert the container with samples into the container holders on the rotor. The container holders 70 are arranged radially in the rotor 40. In an embodiment of a rotor, sixteen container holders 70 may be present so that the centrifuge can be operated with a maximum number of sixteen containers. The containers are loaded symmetrically in the rotor so that no imbalance occurs during centrifugation. Furthermore, when the centrifuge is loaded with an uneven number of containers, the counterweight container is inserted into a container holder on the rotor so that the symmetry is achieved in the rotor. The counterweight container is provided in a counterweight container holder outside the housing (comp. FIG. 1). If there is an odd number of processing tubes, this unbalance correction tube is used to produce an even number of tubes and avoid an unbalance during centrifugation. During loading, the rotor rotates slowly and stops at the loading position for each container holder, enabling continuous loading with the shutter open. The speed is monitored via the encoder signals and the Hall sensors.

When all tubes which are to be processed, and optionally the counterweight container have been loaded into the container holders, the shutter flap is closed as described above.

The centrifuge can only be started after the signals from the light barriers meet the safety requirements:
The lid of the centrifuge must be closed; this is monitored by the light barrier on the printed circuit board.
The flap on the shutter must be closed; this is monitored by the two light barriers on the shutter.

For starting the centrifuge, the rotation speed of the rotor is increased via the EC motor. At a certain rotation speed, for instance 28.77/min, the container holders start to swing out due to centrifugal force. At a further increased rotation speed, for instance 50.38/min, the container holder reaches the maximum swing-out angle of about 45° (comp. FIG. 14). The maximum swing-out angle is mechanically fixed via a swing-out stop 99 on the rotor 40. The centrifuge can rotate at a maximum of 3000 revolutions per minute and generate a G-force of at least 200 g and max. 1000 g.

When the centrifugation process is completed, the rotation speed is reduced until the container holders are in the upright position again for unloading. In the next step, the rotor rotates at low speed (permitted speed with open shutter) so that the flap for unloading the container from the shutter can be opened again and access to the container in the centrifugation chamber is released. After the opening is released by the light barriers and the rotor stops, the gripper can unload the container with samples via the opening.

When loading and unloading the container into the container holders of the rotor, the rotor can rotate clockwise or counter clockwise, so that efficient loading and unloading of the container is possible. The position detection of the EC motor by means of an encoder allows the rotor to rotate the shortest way to the opening of the centrifuge. When the centrifuge is not fully loaded, the containers can be loaded or unloaded faster in a clockwise or counter clockwise direction, depending on their position.

The advantages of the invention can be summarized as follows:
Shutter enables automatic loading and unloading of the containers.
No unwanted opening of the flap by the shutter during centrifugation and when the centrifuge is switched on and off.
Position recognition enables more efficient and targeted loading and unloading of containers when the centrifuge is not fully loaded.
Loading with an odd number of tubes is possible.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

### REFERENCE NUMERALS

1 centrifuge

2 base plate

3 keyhole

4 slotted hole

5 housing

6 screw

7 bolt

8 recess

10 lid

11 light barrier

15 printed circuit board (PCB)

20 shutter

21 flap

22 stepper motor

23 toggle lever

24 light barrier stepper motor

25 light barrier flap

26 second opening

27 stop

28 pin-joint

29 recess first lever

30 counterweight container holder

31 counterweight container

40 rotor

41 recess rotor

45 fixation tool

50 centrifuge chamber

51 first opening

60 EC motor with encoder

70 container holder

71 container

80 nut

81 axis of rotation

90 teach tool

91 elevation

95 axis container holder

97 spring

99 swing-out stop

281 first lever

282 second lever

What is claimed is:

1. A centrifuge for separating compounds of a fluid, comprising:
a housing surrounding a centrifugation chamber;
a lid with a first opening;
a printed circuit board;
a rotor with a plurality of container holders; and
a shutter which partly covers the lid, wherein the shutter comprises:
a second opening which is arranged above the first opening of the lid; and
a stepper motor for actuating a toggle lever which is connected to a rotatable flap that is arranged above the first opening of the lid and below the second opening of the shutter.

2. The centrifuge of claim 1, wherein the rotor is connected to an EC motor with encoder.

3. The centrifuge of claim 1, wherein the plurality of container holders is radially arranged around a central axis of rotation.

4. The centrifuge of claim 1, wherein the plurality of container holders is movably and spring-loaded connected to the rotor allowing each container holder to swing-out due to centrifugal forces.

5. The centrifuge of claim 4, wherein the spring-loaded connection of the plurality of container holders to the rotor comprises an axis and a spring surrounding said axis of swing-out of each container holder.

6. The centrifuge of claim 1, wherein the toggle lever comprises a first lever which is connected on one side to the stepper motor and on the other side through a joint-pin to a second lever which is connected to the flap.

7. The centrifuge of claim 1, wherein the shutter comprises a first light barrier arranged at the stepper motor and a second light barrier arranged at the flap.

8. The centrifuge of claim 6, wherein the first lever comprises a recess.

9. The centrifuge of claim 7, wherein the end of first lever which is connected to the stepper motor is configured to interrupt the first light barrier and the flap is configured to interrupt the second light barrier.

10. The centrifuge of claim 1, comprising on the outside of the housing a counterweight container holder for accommodating a counterweight container.

11. The centrifuge of claim 1, wherein the rotor comprises a stop for limiting the swing-out angle of the plurality of container holders.

12. A method for loading and unloading container to a rotor of a centrifuge with a gripper, comprising the steps of:
monitoring the speed of rotation of a rotor;
opening a flap of a shutter when the rotor speed is below a pre-defined threshold by actuating a stepper motor of the shutter, wherein the stepper motor is connected by a toggle lever to the flap that is arranged above a first opening of the lid and below an upper plate of the shutter;
stopping the rotation of the rotor;
loading or unloading the container into or from a container holder with a gripper;
closing the first opening of the lid by actuating the stepper motor connected to the flap;
monitoring whether the flap is closed by a first light barrier that is arranged at the stepper motor and a second light barrier that is arranged at the flap; and
accelerating the rotor when the flap of the shutter is closed.

13. The method of claim 12, comprising the step of detecting the position of a container holder using an EC motor with encoder.

14. The method of claim 12, wherein the rotor rotates clockwise or counter clockwise depending on the detected position of the container holder for loading or unloading.

15. The method of claim 12, wherein the flap of the shutter is opened when the rotor is stationary.
